(19) United States
(12) Patent Application Publication
(10) Pub. No.: US 2010/0044361 A1
(43) Pub. Date: Feb. 25, 2010

(54) HEATING MODULE OF LIQUID CRYSTAL DISPLAY AND METHOD FOR HEATING LIQUID CRYSTALS THEREOF

(76) Inventors: Chih-Hsiung LIN, Taipei (TW); Kai-Chen TIEN, Taipei (TW)

Correspondence Address: Muncy, Geissler, Olds & Lowe, PLLC, P.O. BOX 1364, FAIRFAX, VA, 22038-1364, US

(21) Appl. No.: 12/402,169

(22) Filed: Mar. 11, 2009

(30) Foreign Application Priority Data
Aug. 20, 2008 (TW) 097131761

(51) Int. Cl. H05B 1/00

(52) U.S. Cl. 219/209

(57) ABSTRACT

The invention discloses a heating module of a liquid crystal display and a method for heating liquid crystals thereof. The liquid crystal display includes a first glass panel, a second glass panel, and a liquid crystal layer disposed between the first glass panel and the second glass panel. The method for heating the liquid crystals includes the following steps. First, temperatures of the first glass panel and the second glass panel are sensed. According to values of the temperatures of the first glass panel and the second glass panel, an average temperature of the liquid crystal layer is computed. Afterwards, the average temperature is compared with a predetermined temperature. When the average temperature is lower than the predetermined temperature, the liquid crystal display is heated.

### CROSS REFERENCE TO RELATED APPLICATIONS

This Non-provisional application claims priority under 35 U.S.C. §119(a) on Patent Application No(s). 097131761 filed in Taiwan, Republic of China on Aug. 20, 2008, the entire contents of which are hereby incorporated by reference.

### BACKGROUND OF THE INVENTION

1. Field of Invention

The invention relates to a liquid crystal display and, more particularly, to a liquid crystal display with a heating module and a method for heating liquid crystals thereof.

2. Related Art

In recent years, personal computers and televisions are developed toward lightness and thinness, and therefore, displays are designed to be lighter and thinner day by day. Thus, flat panel displays including liquid crystal displays (LCD) have replaced conventional cathode ray tube (CRT) displays.

FIG. 1 is a schematic diagram showing a structure of a conventional liquid crystal display. As shown in FIG. 1, a liquid crystal display 1 includes a liquid crystal display panel 10 and a backlight module 20. The backlight module 20 is disposed at the bottom of the liquid crystal display panel 10.

The liquid crystal display panel 10 includes a first glass panel 11, a second glass panel 12, and a liquid crystal layer 13. The first glass panel 11 and the second glass panel 12 are opposite to each other, and the liquid crystal layer 13 is disposed between the first glass panel 11 and the second glass panel 12.

The backlight module 20 includes a light source 21 and a light guiding plate 22. The light source 21 is disposed relative to the light guiding plate 22. The light emitted from the light source 21 enters the liquid crystal display panel 10 through the light guiding plate 22. At that moment, the arrangement of liquid crystal molecules of the liquid crystal layer 13 changes the angle at which the light penetrates through the liquid crystal molecules. Thus, images displayed by the liquid crystal display 1 are controlled.

The light source 21 is generally a cold cathode fluorescent lamp (CCFL) or a light emitting diode (LED).

However, the liquid crystal display has the following problems in usage. The temperature of the liquid crystal molecules of the liquid crystal layer 13 is balanced with the temperature of an external environment. That is, the temperature of the liquid crystal molecules is affected by the external environment. When the liquid crystal display 1 is under a low temperature environment, and the temperature of the external environment is lower than an operating temperature of liquid crystal materials, the low temperature of the external environment decreases the temperature of the whole liquid crystal display 1 to slow the reaction rate of the liquid crystal molecules. Thus, when the liquid crystal display 1 shows dynamic images, afterimages are easy to happen. Furthermore, a contrast ratio of the liquid crystal display 1 reduces, or the color shown by the liquid crystal display 1 becomes uneven, which affects image quality.

### SUMMARY OF THE INVENTION

One objective of the invention is to provide a heating module of a liquid crystal display (LCD) and a method for heating liquid crystals thereof to improve the conventional technology.

According to one aspect of the invention, the invention provides a heating module of a liquid crystal display. The liquid crystal display includes a first glass panel, a second glass panel, and a liquid crystal layer disposed between the first glass panel and the second glass panel. The heating module includes a temperature sensing unit, a heating unit, and a controller. The temperature sensing unit includes a first temperature sensor and a second temperature sensor. The first temperature sensor is coupled with the first glass panel, and the second temperature sensor is coupled with the second glass panel. The temperature sensing unit utilizes the first temperature sensor and the second temperature sensor to compute an average temperature of the liquid crystal layer and compares the average temperature with a predetermined temperature. The heating unit is disposed at the first glass panel. The controller is coupled with the temperature sensing unit and the heating unit. When the average temperature is lower than the predetermined temperature, the controller controls the heating unit to heat.

According to another aspect of the invention, the invention provides a method for heating liquid crystals adapted for a liquid crystal display. The liquid crystal display includes a first glass panel, a second glass panel, and a liquid crystal layer disposed between the first glass panel and the second glass panel. The method for heating the liquid crystal includes the following steps. First, temperatures of the first glass panel and the second glass panel are sensed. According to values of the temperatures of the first glass panel and the second glass panel, an average temperature of the liquid crystal layer is computed. Afterwards, the average temperature is compared with a predetermined temperature. When the average temperature is lower than the predetermined temperature, the liquid crystal display is heated.

To sum up, when the temperature of the liquid crystal is lower than the predetermined temperature, the heating module of the liquid crystal display in the invention can control the heating unit to heat. Furthermore, in the invention, the sensed temperatures of the first glass panel and the second glass panel are used to compute the average temperature of the liquid crystal layer. Thus, an actual temperature of the liquid crystal layer can be obtained accurately, and according to the actual temperature, whether the heating unit is controlled to heat is determined.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a structure of a conventional liquid crystal display.

FIG. 2 is a block diagram of a heating module of a liquid crystal display according to a preferred embodiment of the invention.

FIG. 3 is a schematic diagram showing a heating module of a liquid crystal display disposed at the liquid crystal display according to a preferred embodiment of the invention.

FIG. 4A is a three-dimensional schematic diagram of a liquid crystal display according to a preferred embodiment of the invention.

FIG. 4B is a three-dimensional schematic diagram of a liquid crystal display according to another preferred embodiment of the invention.

FIG. 5 is a flowchart of a method for heating liquid crystals of a liquid crystal display according to a preferred embodiment of the invention.

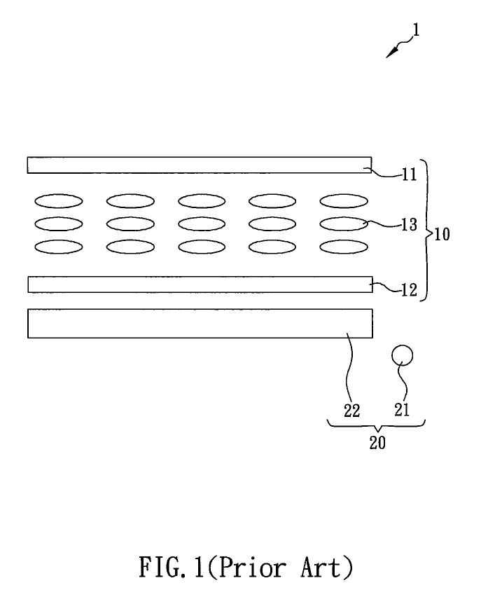

### DETAILED DESCRIPTION OF THE INVENTION

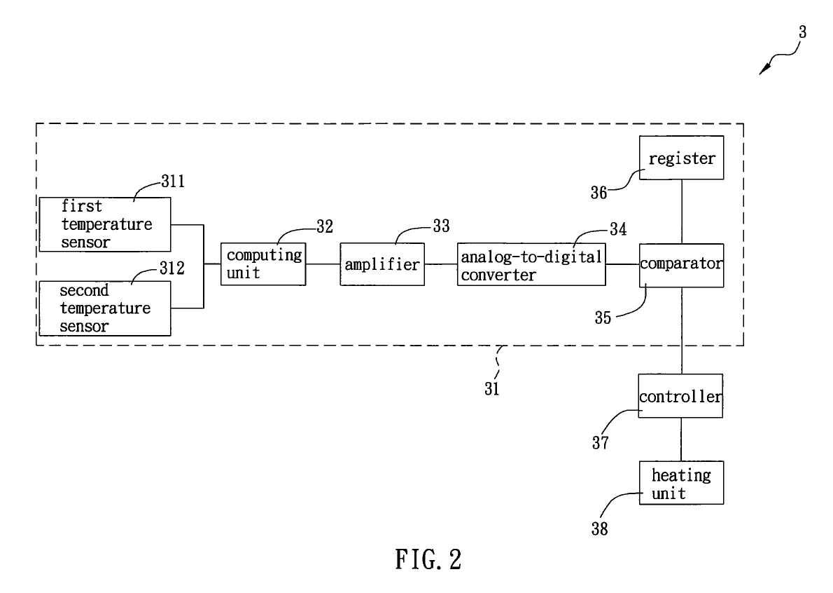

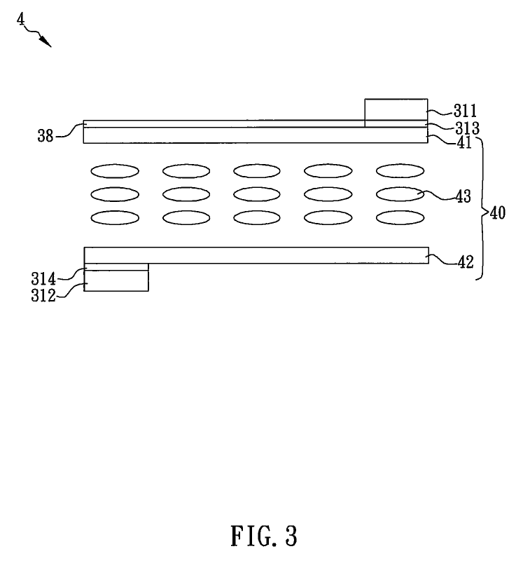

FIG. 2 is a block diagram of a heating module of a liquid crystal display according to a preferred embodiment of the invention. FIG. 3 is a schematic diagram showing the heating module of the liquid crystal display disposed at the liquid crystal display according to a preferred embodiment of the invention.

In the embodiment, a heating module 3 includes a temperature sensing unit 31, a first flexible circuit board 313, a second flexible circuit board 314, a controller 37, and a heating unit 38.

In the embodiment, the temperature sensing unit 31 further includes a first temperature sensor 311, a second temperature sensor 312, a computing unit 32, an amplifier 33, an analog-to-digital converter 34, a comparator 35, and a register 36. In other embodiments, the temperature sensing unit 31 may be a digital temperature sensing integrated circuit (IC).

The controller 37 is coupled with the temperature sensing unit 31 and the heating unit 38. The first temperature sensor 311 and the second temperature sensor 312 are coupled with the computing unit 32, respectively. The amplifier 33 is coupled with the computing unit 32 and the analog-to-digital converter 34, respectively. The analog-to-digital converter 34 is coupled with the comparator 35. The comparator 35 is coupled with the register 36 and the controller 37, respectively.

In the embodiment, a liquid crystal display panel 40 of a liquid crystal display 4 includes a first glass panel 41, a second glass panel 42, and a liquid crystal layer 43. The liquid crystal layer 43 is disposed between the first glass panel 41 and the second glass panel 42. In the embodiment, the first glass panel 41 is a filter glass substrate, and the second glass panel 42 is a thin-film transistor (TFT) glass substrate. This does not limit the scope of the invention. In other embodiments, the first glass panel 41 may be a TFT glass substrate, and the second glass panel 42 may be a filter glass substrate.

In the embodiment, the first flexible circuit board 313 of the heating module 3 is disposed at the first glass panel 41 of the liquid crystal display panel 40, and the second flexible circuit board 314 of the heating module 3 is disposed at the second glass panel 42 of the liquid crystal display panel 40. Thereby, the first temperature sensor 311 of the temperature sensing unit 31 may be disposed at the first flexible circuit board 313 to sense the temperature of the first glass panel 41. The second temperature sensor 312 of the temperature sensing unit 31 may be disposed at the second flexible circuit board 314 to sense the temperature of the second glass panel 42.

In the embodiment, the heating unit 38 may be a heating film or a heating wire, and it is disposed at the first glass panel 41 of the liquid crystal display panel 40. This does not limit the scope of the invention. In other embodiments, the heating unit 38 may also be disposed at the second glass panel 42 of the liquid crystal display panel 40, or the heating unit 38 may be disposed at the first glass panel 41 and the second glass panel 42, respectively.

In the embodiment, the first temperature sensor 311 senses the temperature T₁ of the first glass panel 41, and the second temperature sensor 312 senses the temperature T₂ of the second glass panel 42. Then, the computing unit 32 computes an average temperature T₃ of the liquid crystal layer 43 according to the temperature T₁ sensed by the first temperature sensor 311 and the temperature T₂ sensed by the second temperature sensor 312. The average temperature T₃ of the liquid crystal layer 43 is an average of the temperature T₁ of the first glass panel 41 and the temperature T₂ of the second glass panel 42, that is, T₃=(T₁+T₂)/2.

Afterwards, the amplifier 33 and the analog-to-digital converter 34 convert the average temperature T₃ of the liquid crystal layer 43 to a digital signal and transmit the digital signal to the comparator 35.

When the comparator 35 receives the digital signal transmitted from the analog-to-digital converter 34, it compares the value of the digital signal with the value of a predetermined temperature stored in the register 36 and controls operation of the controller 37 according to the comparative result. For example, when the value of the digital signal is lower than the value of the predetermined temperature, the comparator 35 outputs a control signal in a first state to the controller 37. In the embodiment, the first state may be a low level state.

In the embodiment, after the controller 37 receives the control signal in the first state, it controls the heating unit 38 to heat. In detail, the heat generated by the heating unit 38 is first conducted to the first glass panel 41, and then it is conducted to the liquid crystal layer 43. Thereby, heating the liquid crystal layer 43 is realized.

When the value of the digital signal is higher than the value of the predetermined temperature, the comparator 35 outputs a control signal in a second state to the controller 37. In the embodiment, the second state may be a high level state. The controller 37 stops heating of the heating unit 38 according to the control signal in the second state.

When the heating module 3 is used in a portable electronic device such as a notebook computer, the controller 37 may be an embedded controller (EC). In other embodiments, the heating module 3 may be a super input/output chip or a microprocessor. In detail, when the controller 37 is an embedded controller, it generally includes pins provided for users to define the pins by themselves. Thus, the embedded controller may be programmed to control the heating unit 38.

Furthermore, the value of the predetermined temperature in the temperature sensing unit 31 may be adjusted by software. For example, the predetermined temperature is initialized to be −20° C., and the predetermined temperature may be adjusted to be −15° C. via the setting of a basic input/output system (BIOS) of the portable electronic device.

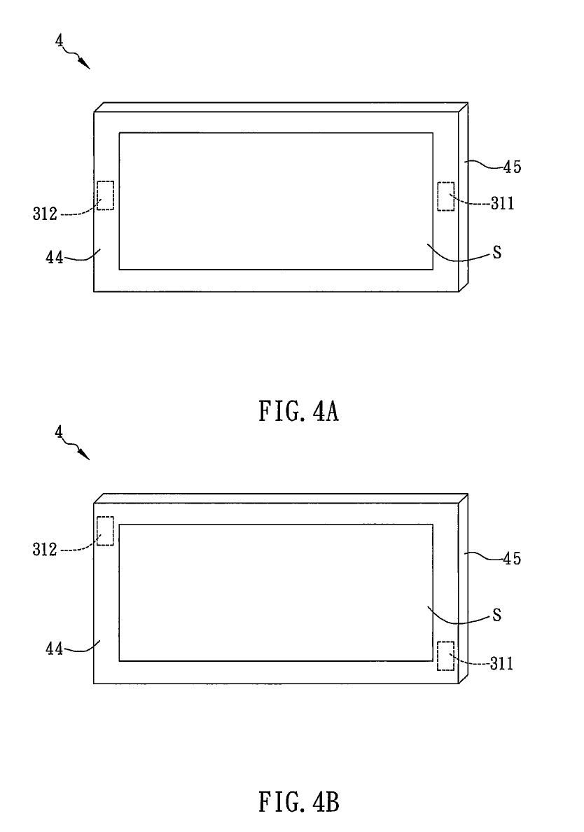

FIG. 4A is a three-dimensional schematic diagram of a liquid crystal display according to a preferred embodiment of the invention. As shown in FIG. 4A, in the embodiment, the liquid crystal display 4 further includes a rectangular frame 44 and a casing 45. The rectangular frame 44 and the casing 45 are connected to each other to form a containing space S. The first glass panel 41, the liquid crystal layer 43, and the second glass panel 42 are disposed in the containing space S in turn.

In the embodiment, the casing 45 may be connected with the second glass panel 42 in FIG. 3, and the second temperature sensor 312 is disposed between the casing 45 and the second glass panel 42.

The rectangular frame 44 may be connected with the first glass panel 41 in FIG. 3, and the first temperature sensor 311 is disposed between the rectangular frame 44 and the first glass panel 41. Thus, the rectangular frame 44 may cover the first temperature sensor 311.

In the embodiment, orthographic projections of the first temperature sensor 311 and the second temperature sensor 312 on the rectangular frame 44 are located at two opposite lateral sides of the rectangular frame 44, such as left and light lateral sides in FIG. 4A, respectively, and they are in symmetric relation. Thus, the average temperature of the liquid crystal layer can be computed accurately. This does not limit the scope of the invention. In other embodiments, the orthographic projections of the first temperature sensor 311 and the second temperature sensor 312 on the rectangular frame 44 are located at the upper and lower lateral sides of the rectangular frame 44, respectively.

FIG. 4B is a three-dimensional schematic diagram of a liquid crystal display according to another preferred embodiment of the invention. As shown in FIG. 4B, the liquid crystal display 4 further includes a rectangular frame 44 and a casing 45. Positions of the frame 44 and the casing 45 are the same with the positions of the frame 44 and the casing 45 in FIG. 4A. Therefore, they are not described hereinbelow for a concise purpose.

However, in the embodiment, orthographic projections of the first temperature sensor 311 and the second temperature sensor 312 on the rectangular frame 44 are located at two corners of the rectangular frame 44, such as a top left corner and a bottom right corner in FIG. 4B, respectively, and they are in diagonal relation. Thus, the average temperature of the liquid crystal layer can be computed accurately. This does not limit the scope of the invention. In other embodiments, the orthographic projections of the first temperature sensor 311 and the second temperature sensor 312 on the rectangular frame 44 are located at a top right corner and a bottom left corner of the rectangular frame 44, respectively.

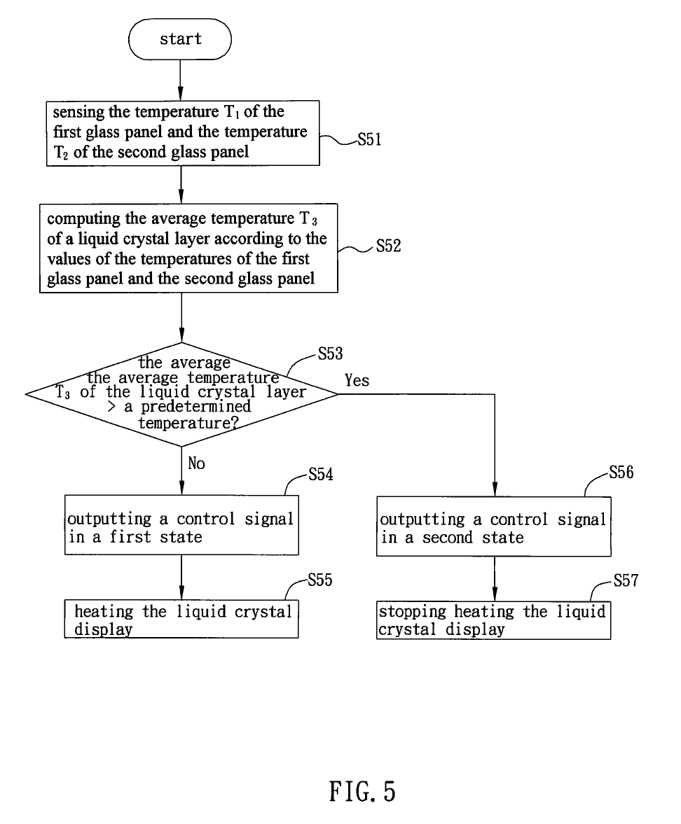

FIG. 5 is a flowchart of a method for heating liquid crystals of a liquid crystal display according to a preferred embodiment of the invention. The descriptions of the method may refer to FIG. 2, FIG. 3, and FIG. 5.

First, in step S51, the first temperature sensor 311 of the temperature sensing unit 31 senses the temperature T₁ of the first glass panel 41, and the second temperature sensor 312 senses the temperature T₂ of the second glass panel 42.

Then, in step S52, the computing unit 32 of the temperature sensing unit 31 receives the temperature T₁ of the first glass panel 41 and the temperature T₂ of the second glass panel 42 to compute an average temperature T₃ of the liquid crystal layer 43, that is, T₃=(T₁+T₂)/2.

In step S53, the temperature sensing unit 31 compares the computed average temperature T₃ of the liquid crystal layer 43 with a predetermined temperature, and then it outputs a control signal according to the comparative result.

In detail, as stated in step S54, when the average temperature T₃ of the liquid crystal layer 43 is lower than the predetermined temperature, the temperature sensing unit 31 outputs a control signal in a first state. In the embodiment, the first state is a low level state.

Afterwards, as stated in step S55, when the controller 37 receives the control signal in a first state, it controls the heating unit 38 to heat the liquid crystal display 4.

As stated in step S56, when the average temperature T₃ of the liquid crystal layer 43 is higher than the predetermined temperature, the temperature sensing unit 31 outputs a control signal in a second state. In the embodiment, the second state is a high level state.

Afterwards, as stated in step S57, when the controller 37 receives the control signal in the second state, it controls the heating unit 38 to stop heating the liquid crystal display 4.

To sump up, the heating module disclosed in the preferred embodiment of the invention utilizes the sensed temperatures of the first glass panel and the second glass panel to compute the average temperature of the liquid crystal layer. Thus, the actual temperature of the liquid crystal layer can be obtained accurately. Furthermore, when the computed average temperature of the liquid crystal layer is lower than the predetermined temperature, the controller controls the heating unit to heat. Thus, the liquid crystal display can operate normally under a low temperature environment.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A heating module of a liquid crystal display (LCD), the liquid crystal display including a first glass panel, a second glass panel, and a liquid crystal layer disposed between the first glass panel and the second glass panel, the heating module comprising:
a temperature sensing unit including a first temperature sensor and a second temperature sensor, the first temperature sensor coupled with the first glass panel, the second temperature sensor coupled with the second glass panel, the temperature sensing unit utilizing the first temperature sensor and the second temperature sensor to compute an average temperature of the liquid crystal layer, and the temperature sensing unit comparing the average temperature with a predetermined temperature;
a heating unit disposed at the first glass panel; and
a controller coupled with the temperature sensing unit and the heating unit, wherein when the average temperature is lower than the predetermined temperature, the controller controls the heating unit to heat.

2. The heating module according to claim 1, wherein the heating unit is a heating film or a heating wire.

3. The heating module according to claim 1, wherein the heating module further comprises a first flexible circuit board and a second flexible circuit board disposed at the first glass panel and the second glass panel of the liquid crystal display, respectively, the first temperature sensor is disposed on the first flexible circuit board, and the second temperature sensor is disposed on the second flexible circuit board.

4. The heating module according to claim 1, wherein the average temperature of the liquid crystal layer of the liquid crystal display is the average of the temperature of the first glass panel and the temperature of the second glass panel.

5. The heating module according to claim 1, wherein the temperature sensing unit outputs a control signal, and the controller determines whether to control the heating unit to heat according to the control signal.

6. The heating module according to claim 5, wherein when the average temperature of the liquid crystal layer of the liquid crystal display is lower than the predetermined temperature, the control signal is in a first state, and the controller controls the heating unit to heat.

7. The heating module according to claim 6, wherein when the average temperature of the liquid crystal layer of the liquid crystal display is higher than the predetermined temperature, the control signal is in a second state, and the controller controls the heating unit to stop heating.

8. The heating module according to claim 1, wherein the temperature sensing unit further comprises a register for storing the value of the predetermined temperature.

9. The heating module according to claim 1, wherein the heating module is adapted for a portable electronic device.

10. The heating module according to claim 9, wherein the controller is an embedded controller, a super input/output chip, or a microprocessor.

11. The heating module according to claim 9, wherein the portable electronic device comprises a basic input/output system (BIOS) for adjusting the value of the predetermined temperature.

12. The heating module according to claim 1, wherein the liquid crystal display further comprises:
a casing connected with the second glass panel, wherein the second temperature sensor is disposed between the casing and the second glass panel; and
a rectangular frame connected with the casing and the first glass panel, wherein the first temperature sensor is disposed between the rectangular frame and the first glass panel.

13. The heating module according to claim 12, wherein orthographic projections of the first temperature sensor and the second temperature sensor on the rectangular frame are located at two opposite lateral sides of the rectangular frame, respectively, and they are in symmetric relation.

14. The heating module according to claim 12, wherein orthographic projections of the first temperature sensor and the second temperature sensor on the rectangular frame are located at two corners of the rectangular frame, respectively, and they are in diagonal relation.

15. A method for heating liquid crystals of a liquid crystal display, the liquid crystal display including a first glass panel, a second glass panel, and a liquid crystal layer disposed between the first glass panel and the second glass panel, the method comprising the steps of:
sensing the temperatures of the first glass panel and the second glass panel;
computing an average temperature of the liquid crystal layer according to the values of the temperatures of the first glass panel and the second glass panel;
comparing the average temperature with a predetermined temperature; and
when the average temperature is lower than the predetermined temperature, heating the liquid crystal display.

16. The method for heating the liquid crystals according to claim 15, wherein the average temperature is the average of the temperature of the first glass panel and the temperature of the second glass panel.

17. The method for heating the liquid crystals according to claim 15, further comprising the step of:
after comparing the average temperature with the predetermined temperature, outputting a control signal.

18. The method for heating the liquid crystals according to claim 17, wherein when the average temperature is lower than the predetermined temperature, the control signal is in a first state, and the liquid crystal display is heated.

19. The method for heating the liquid crystals according to claim 18, wherein when the average temperature is higher than the predetermined temperature, the control signal is in a second state, and the liquid crystal display stops being heated.
